(19) United States
(12) Patent Application Publication
(10) Pub. No.: US 2018/0337873 A1
(43) Pub. Date: Nov. 22, 2018

(54) DYNAMICALLY UPDATING ELECTRONIC MAIL

(71) Applicant: salesforce.com, Inc., San Francisco, CA (US)

(72) Inventors: Tyler Kanyon Clark, Tampa, FL (US); Alexander Joseph Baden, Tampa, FL (US); Sreejesh Divakaran Nair, Tampa, FL (US)

(73) Assignee: salesforce.com, inc., San Francisco, CA (US)

(21) Appl. No.: 15/596,990

(22) Filed: May 16, 2017

(51) Int. Cl. H04L 12/58; H04L 29/08; G06F 9/54

(52) U.S. Cl. CPC H04L 51/04; H04L 51/16; G06F 9/547; H04L 51/32; H04L 67/02; H04L 51/08

(57) ABSTRACT

Email updating apparatuses and methods of updating an email are disclosed herein. In embodiments, a method of updating emails may be provided. The method may include identifying an email selected for opening by a user on a client device, scanning the email, determining if the email refers to a message thread or social media post on a message service provider's server, obtaining contents of the message thread or social media post that were added subsequent to the sending of the email from the message service provider's server, and displaying the email to the user with the added contents. Other embodiments may be disclosed or claimed.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### TECHNICAL FIELD

The technology relates to email communications and more specifically to a web browser extension that dynamically updates electronic mail referring to a message thread by accessing the message thread, obtaining the latest message and inserting the then complete thread into the email.

### BACKGROUND

Email users often receive a series of emails that report a post of some sort that was made on a website or social media environment that the user participates in. Such websites or environments often use threaded messaging. Threaded messaging displays all sides of a messaging conversation on one screen, in chronological order. Thus, with threaded messaging, messages from various people participating in the post, chat, discussion thread or the like, are mixed together in the thread, instead of being grouped by person or time sent, posted or received.

While the actual websites or social media environments, such as, for example, Facebook™, Whatsapp™, etc., organize posts in threads, such websites, applications and environments also have a notification feature. The notification feature sends a user an email advising he or she that a new message, post or other content (e.g., photo or audio file) has been added to the thread. Upon receiving such a notification email, the user may open the email and click on a link to the actual website or social media platform, and view the entirely of message in the thread. If a user does not open emails continually, he or she may have a number of such notification emails in his or her inbox. If the user opens up one of those emails reporting such a post, but the email is not the last one received from the website or social media platform, in the email itself the user will only see an earlier version of the message thread, and the information that the notification email presents regarding the thread may be stale. Not knowing this fact, the user may proceed to click on the link, and open a browser window displaying the message thread in the website or platform. Once the entire thread is seen, it may be clear that the earlier content of the thread, which was contained in the notification email.

### BRIEF DESCRIPTION OF THE DRAWINGS

The included drawings are for illustrative purposes and serve to provide examples of possible structures and operations for the disclosed inventive systems, apparatus, methods and computer-readable storage media. These drawings in no way limit any changes in form and detail that may be made by one skilled in the art without departing from the spirit and scope of the disclosed implementations.

FIG. 1A shows a block diagram of an example environment in which an on-demand database service can be used according to some implementations.

FIG. 1B shows a block diagram of example implementations of elements of FIG. 1A and example interconnections between these elements according to some implementations.

FIG. 2A shows a block diagram of an example environment in which an email update application may be used according to some embodiments.

FIG. 2B shows a block diagram of an alternate example environment in which an email update application may be used according to some embodiments.

FIG. 3 shows an example process for identifying and updating emails.

FIG. 4 illustrates a block diagram of a computer device suitable for practicing the present disclosure, in accordance with various embodiments.

FIG. 5 illustrates an example computer-readable storage medium having instructions configured to practice aspects of the process of FIG. 3, in accordance with various embodiments.

FIG. 6 illustrates an email received in a web-based email account, notifying the user of a post in a group on a Salesforce.com platform in accordance with various embodiments.

FIG. 7 illustrates the email shown in FIG. 6, once opened, in accordance with various embodiments.

FIG. 8 illustrates opening the message on the threaded message platform as a result of clicking on the View/Comment button in the message notification email shown in FIG. 7, in accordance with various embodiments.

FIG. 9 illustrates the opened message thread on the threaded message platform with additional messages posted subsequent to the message shown in the notification email depicted in FIG. 7, in accordance with various embodiments.

FIG. 10 illustrates the same email as shown in FIG. 7, as accessed from the user's web-based email account, with the updated messages from the message thread on the threaded message platform now added to the notification email, in accordance with various embodiments.

FIG. 11 illustrates a new message being posted in the message thread on the threaded message platform in real time, in accordance with various embodiments.

FIG. 12 illustrates the same email shown in FIG. 10 as updated in real time with the new message just entered on the Salesforce.com platform message thread, as shown in FIG. 11, in accordance with various embodiments.

### DETAILED DESCRIPTION

Examples of systems, apparatus, computer-readable storage media, and methods according to the disclosed implementations are described in this section. These examples are being provided solely to add context and aid in the understanding of the disclosed implementations. It will thus be apparent to one skilled in the art that the disclosed implementations may be practiced without some or all of the specific details provided. In other instances, certain process or method operations, also referred to herein as “blocks,” have not been described in detail in order to avoid unnecessarily obscuring the disclosed implementations. Other implementations and applications also are possible, and as such, the following examples should not be taken as definitive or limiting either in scope or setting.

In the following detailed description, references are made to the accompanying drawings, which form a part of the description and in which are shown, by way of illustration, specific implementations. Although these disclosed implementations are described in sufficient detail to enable one skilled in the art to practice the implementations, it is to be understood that these examples are not limiting, such that other implementations may be used and changes may be made to the disclosed implementations without departing from their spirit and scope. For example, the blocks of the methods shown and described herein are not necessarily performed in the order indicated in some other implementations. Additionally, in some other implementations, the disclosed methods may include more or fewer blocks than are described. As another example, some blocks described herein as separate blocks may be combined in some other implementations. Conversely, what may be described herein as a single block may be implemented in multiple blocks in some other implementations. Additionally, the conjunction “or” is intended herein in the inclusive sense where appropriate unless otherwise indicated; that is, the phrase “A, B or C” is intended to include the possibilities of “A,” “B,” “C,” “A and B,” “B and C,” “A and C” and “A, B and C.”

Some implementations described and referenced herein are directed to systems, apparatus, computer-implemented methods and computer-readable storage media for dynamically updating emails.

A database system might display a case associated with a customer support query. The database system may initiate a search for other cases related to the new case. The database system may extract relevant terms from the title and/or description provided in the new case using a term weighting algorithm, such as more like this (MLT). The relevant terms are then used in a search query for identifying the related cases.

The database system identifies articles linked to the related cases, ranks the articles, and causes the articles to be displayed on a remote user system in an order based on the ranking. The database system may rank the articles based on a number of related cases linked to the articles. The database system also may rank the article based on other parameters, such as relevancy scores for the related cases, labels assigned to the cases, last modified dates of the related cases, etc.

The database system may identify more relevant articles by first finding related cases that use a similar vocabulary to describe similar customer problems. The database system then identifies the articles that were previously determined to help resolve the prior problems. Thus, the database system may bridge the gap between vocabularies used by customers to describe problems and vocabularies used in articles to describe solutions to those problems.

In some implementations, the users described herein are users (or “members”) of an interactive online “enterprise social network,” also referred to herein as an “enterprise social networking system,” an “enterprise collaborative network,” or more simply as an “enterprise network.” Such online enterprise networks are increasingly becoming a common way to facilitate communication among people, any of whom can be recognized as enterprise users. One example of an online enterprise social network is Chatter®, provided by salesforce.corn, inc. of San Francisco, Calif. salesforce.com, inc. is a provider of enterprise social networking services, customer relationship management (CRM) services and other database management services, any of which can be accessed and used in conjunction with the techniques disclosed herein in some implementations. These various services can be provided in a cloud computing environment as described herein, for example, in the context of a multi-tenant database system. Some of the described techniques or processes can be implemented without having to install software locally, that is, on computing devices of users interacting with services available through the cloud. While the disclosed implementations may be described with reference to Chatter® and more generally to enterprise social networking, those of ordinary skill in the art should understand that the disclosed techniques are neither limited to Chatter® nor to any other services and systems provided by salesforce.com, inc. and can be implemented in the context of various other database systems such as cloud-based systems that are not part of a multi-tenant database system or which do not provide enterprise social networking services.

### Example System Overview

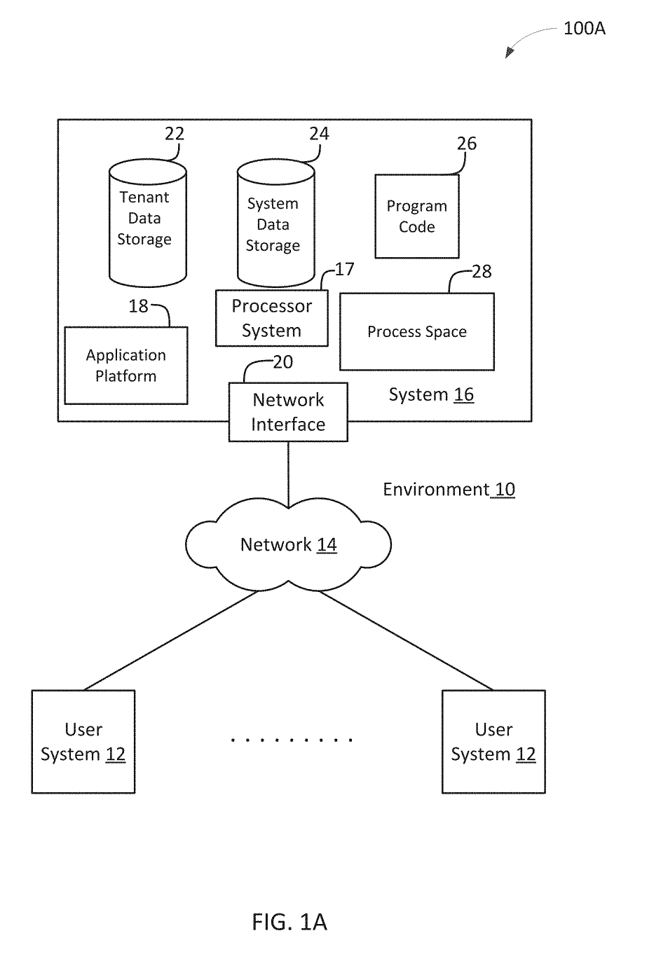

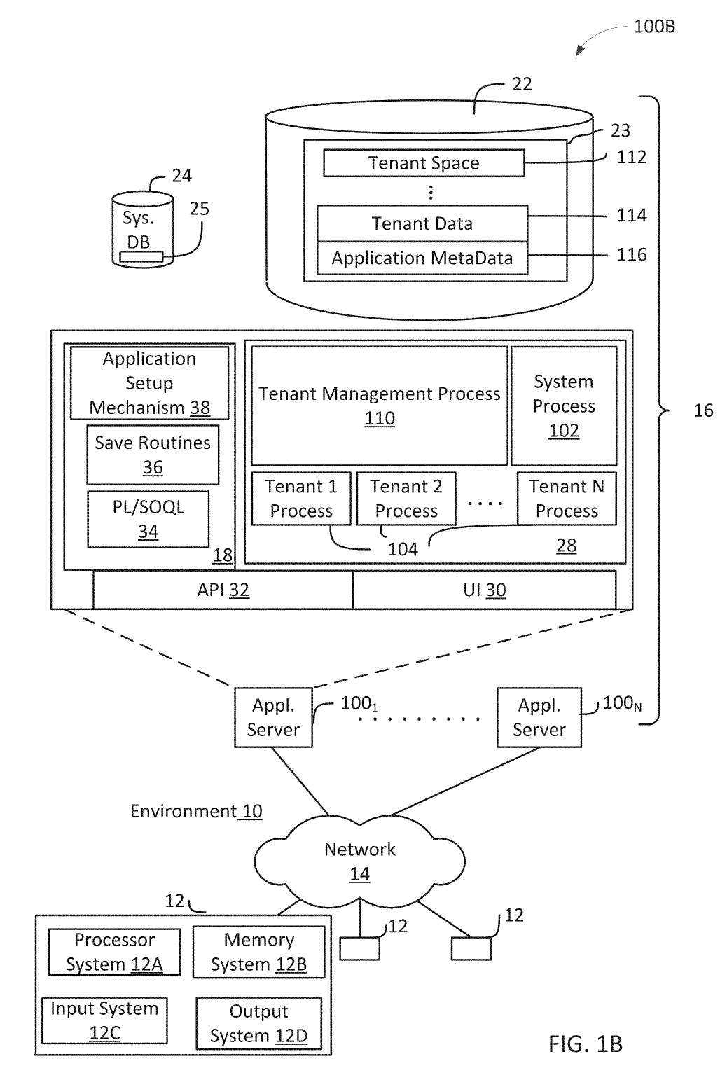

FIG. 1A shows a block diagram of an example of an environment 10 in which an on-demand database service can be used in accordance with some implementations. The environment 10 includes user systems 12, a network 14, a database system 16 (also referred to herein as a “cloud-based system”), a processor system 17, an application platform 18, a network interface 20, tenant database 22 for storing tenant data 23, system database 24 for storing system data 25, program code 26 for implementing various functions of the system 16, and process space 28 for executing database system processes and tenant-specific processes, such as running applications as part of an application hosting service. In some other implementations, environment 10 may not have all of these components or systems, or may have other components or systems instead of, or in addition to, those listed above.

In some implementations, the environment 10 is an environment in which an on-demand database service exists. An on-demand database service, such as that which can be implemented using the system 16, is a service that is made available to users outside of the enterprise(s) that own, maintain or provide access to the system 16. As described above, such users generally do not need to be concerned with building or maintaining the system 16. Instead, resources provided by the system 16 may be available for such users' use when the users need services provided by the system 16; that is, on the demand of the users. Some on-demand database services can store information from one or more tenants into tables of a common database image to form a multi-tenant database system (MTS). The term “multi-tenant database system” can refer to those systems in which various elements of hardware and software of a database system may be shared by one or more customers or tenants. For example, a given application server may simultaneously process requests for a great number of customers, and a given database table may store rows of data such as feed items for a potentially much greater number of customers. A database image can include one or more database objects. A relational database management system (RDBMS) or the equivalent can execute storage and retrieval of information against the database object(s).

Application platform 18 can be a framework that allows the applications of system 16 to execute, such as the hardware or software infrastructure of the system 16. In some implementations, the application platform 18 enables the creation, management and execution of one or more applications developed by the provider of the on-demand database service, users accessing the on-demand database service via user systems 12, or third party application developers accessing the on-demand database service via user systems 12.

In some implementations, the system 16 implements a web-based customer relationship management (CRM) system. For example, in some such implementations, the system 16 includes application servers configured to implement and execute CRM software applications as well as provide related data, code, forms, renderable web pages and documents and other information to and from user systems 12 and to store to, and retrieve from, a database system related data, objects, and Web page content. In some MTS implementations, data for multiple tenants may be stored in the same physical database object in tenant database 22. In some such implementations, tenant data is arranged in the storage medium(s) of tenant database 22 so that data of one tenant is kept logically separate from that of other tenants so that one tenant does not have access to another tenant's data, unless such data is expressly shared. The system 16 also implements applications other than, or in addition to, a CRM application. For example, the system 16 can provide tenant access to multiple hosted (standard and custom) applications, including a CRM application, User (or third party developer) applications, which may or may not include CRM, may be supported by the application platform 18. The application platform 18 manages the creation and storage of the applications into one or more database objects and the execution of the applications in one or more virtual machines in the process space of the system 16.

According to some implementations, each system 16 is configured to provide web pages, forms, applications, data and media content to user (client) systems 12 to support the access by user systems 12 as tenants of system 16. As such, system 16 provides security mechanisms to keep each tenant's data separate unless the data is shared. If more than one MTS is used, they may be located in close proximity to one another (for example, in a server farm located in a single building or campus), or they may be distributed at locations remote from one another (for example, one or more servers located in city A and one or more servers located in city B). As used herein, each MTS could include one or more logically or physically connected servers distributed locally or across one or more geographic locations. Additionally, the term “server” is meant to refer to a computing device or system, including processing hardware and process space(s), an associated storage medium such as a memory device or database, and, in some instances, a database application (for example, OODBMS or RDBMS) as is well known in the art. It should also be understood that “server system” and “server” are often used interchangeably herein. Similarly, the database objects described herein can be implemented as part of a single database, a distributed database, a collection of distributed databases, a database with redundant online or offline backups or other redundancies, etc., and can include a distributed database or storage network and associated processing intelligence.

The network 14 can be or include any network or combination of networks of systems or devices that communicate with one another. For example, the network 14 can be or include any one or any combination of a LAN (local area network), WAN (wide area network), telephone network, wireless network, cellular network, point-to-point network, star network, token ring network, hub network, or other appropriate configuration. The network 14 can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

The user systems 12 can communicate with system 16 using TCP/IP and, at a higher network level, other common Internet protocols to communicate, such as HTTP, FTP, AFS, WAP, etc. In an example where HTTP is used, each user system 12 can include an HTTP client commonly referred to as a “web browser” or simply a “browser” for sending and receiving HTTP signals to and from an HTTP server of the system 16. Such an HTTP server can be implemented as the sole network interface 20 between the system 16 and the network 14, but other techniques can be used in addition to or instead of these techniques. In some implementations, the network interface 20 between the system 16 and the network 14 includes load sharing functionality, such as round-robin HTTP request distributors to balance loads and distribute incoming HTTP requests evenly over a number of servers. In MTS implementations, each of the servers can have access to the MTS data; however, other alternative configurations may be used instead.

The user systems 12 can be implemented as any computing device(s) or other data processing apparatus or systems usable by users to access the database system 16. For example, any of user systems 12 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer.” As described above, each user system 12 typically executes an HTTP client, for example, a web browsing (or simply “browsing”) program, such as a web browser based on the WebKit platform, Microsoft's Internet Explorer browser, Apple's Safari, Google's Chrome, Opera's browser, or Mozilla's Firefox browser, or the like, allowing a user (for example, a subscriber of on-demand services provided by the system 16) of the user system 12 to access, process and view information, pages and applications available to it from the system 16 over the network 14. User systems 12 may be used to access email servers over the Internet or over another computer network, via a web browser. They may also access email via an email client on a user system 12. User systems 12 may also access threaded message service providers over the Internet or over another computer network, via a web browser. Such a web browser may be augmented by an extension as described below to update emails referring to a threaded message posting. Alternatively, such an email client may be augmented by a plug-in as described below to update emails referring to a threaded message posting.

Each user system 12 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) of the user system 12 in conjunction with pages, forms, applications and other information provided by the system 16 or other systems or servers. For example, the user interface device can be used to access data and applications hosted by system 16, and to perform searches on stored data, and otherwise allow a user to interact with various GUI pages that may be presented to a user. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

The users of user systems 12 may differ in their respective capacities, and the capacity of a particular user system 12 can be entirely determined by permissions (permission levels) for the current user of such user system. For example, where a salesperson is using a particular user system 12 to interact with the system 16, that user system can have the capacities allotted to the salesperson. However, while an administrator is using that user system 12 to interact with the system 16, that user system can have the capacities allotted to that administrator. Where a hierarchical role model is used, users at one permission level can have access to applications, data, and database information accessible by a lower permission level user, but may not have access to certain applications, database information, and data accessible by a user at a higher permission level. Thus, different users generally will have different capabilities with regard to accessing and modifying application and database information, depending on the users' respective security or permission levels (also referred to as “authorizations”).

According to some implementations, each user system 12 and some or all of its components are operator-configurable using applications, such as a browser, including computer code executed using a central processing unit (CPU) such as an Intel Pentium® processor or the like. Similarly, the system 16 (and additional instances of an MTS, where more than one is present) and all of its components can be operator-configurable using application(s) including computer code to run using the processor system 17, which may be implemented to include a CPU, which may include an Intel Pentium® processor or the like, or multiple CPUs.

The system 16 includes tangible computer-readable media having non-transitory instructions stored thereon/in that are executable by or used to program a server or other computing system (or collection of such servers or computing systems) to perform some of the implementation of processes described herein. For example, computer program code 26 can implement instructions for operating and configuring the system 16 to intercommunicate and to process web pages, applications and other data and media content as described herein. In some implementations, the computer code 26 can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing, instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

FIG. 1B shows a block diagram of example implementations of elements of FIG. 1A and example interconnections between these elements according to some implementations. That is, FIG. 13 also illustrates environment 10, but FIG. 1B, various elements of the system 16 and various interconnections between such elements are shown with more specificity according to some more specific implementations. Additionally, in FIG. 1B, the user system 12 includes a processor system 12A, a memory system 12B, an input system 12C, and an output system 12D. The processor system 12A can include any suitable combination of one or more processors. The memory system 123 can include any suitable combination of one or more memory devices. The input system 12C can include any suitable combination of input devices, such as one or more touchscreen interfaces, keyboards, mice, trackballs, scanners, cameras, or interfaces to networks. The output system 12D can include any suitable combination of output devices, such as one or more display devices, printers, or interfaces to networks.

In FIG. 1B, the network interface 20 is implemented as a set of HTTP application servers 1001-100N. Each application server 100, also referred to herein as an “app server”, is configured to communicate with tenant database 22 and the tenant data 23 therein, as well as system database 24 and the system data 25 therein, to serve requests received from the user systems 12. The tenant data 23 can be divided into individual tenant storage spaces 112, which can be physically or logically arranged or divided. Within each tenant storage space 112, user storage 114 and application metadata 116 can similarly be allocated for each user. For example, a copy of a user's most recently used (MRU) items can be stored to user storage 114. Similarly, a copy of MRU items for an entire organization that is a tenant can be stored to tenant storage space 112.

The process space 28 includes system process space 102, individual tenant process spaces 104 and a tenant management process space 110. The application platform 18 includes an application setup mechanism 38 that supports application developers' creation and management of applications. Such applications and others can be saved as metadata into tenant database 22 by save routines 36 for execution by subscribers as one or more tenant process spaces 104 managed by tenant management process 110, for example. Invocations to such applications can be coded using PL/SOQL 34, which provides a programming language style interface extension to API 32. A detailed description of some PL/SOQL language implementations is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, issued on Jun. 1, 2010, and hereby incorporated by reference in its entirety and for all purposes. Invocations to applications can be detected by one or more system processes, which manage retrieving application metadata 116 for the subscriber making the invocation and executing the metadata as an application in a virtual machine.

The system 16 of FIG. 1B also includes a user interface (UI) 30 and an application programming interface (API) 32 to system 16 resident processes to users or developers at user systems 12. In some other implementations, the environment 10 may not have the same elements as those listed above or may have other elements instead of, or in addition to, those listed above.

Each application server 100 can be communicably coupled with tenant database 22 and system database 24, for example, having access to tenant data 23 and system data 25, respectively, via a different network connection. For example, one application server 1001 can be coupled via the network 14 (for example, the Internet), another application server 100N-1 can be coupled via a direct network link, and another application server 100N can be coupled by yet a different network connection. Transfer Control Protocol and Internet Protocol (TCP/IP) are examples of typical protocols that can be used for communicating between application servers 100 and the system 16. However, it will be apparent to one skilled in the art that other transport protocols can be used to optimize the system 16 depending on the network interconnections used.

In some implementations, each application server 100 is configured to handle requests for any user associated with any organization that is a tenant of the system 16. Because it can be desirable to be able to add and remove application servers 100 from the server pool at any time and for various reasons, in some implementations there is no server affinity for a user or organization to a specific application server 100. In some such implementations, an interface system implementing a load balancing function (for example, an F5 Big-IP load balancer) is communicably coupled between the application servers 100 and the user systems 12 to distribute requests to the application servers 100. In one implementation, the load balancer uses a least-connections algorithm to route user requests to the application servers 100. Other examples of load balancing algorithms, such as round robin and observed-response-time, also can be used. For example, in some instances, three consecutive requests from the same user could hit three different application servers 100, and three requests from different users could hit the same application server 100. In this manner, by way of example, system 16 can be a multi-tenant system in which system 16 handles storage of, and access to, different objects, data and applications across disparate users and organizations.

In one example storage use case, one tenant can be a company that employs a sales force where each salesperson uses system 16 to manage aspects of their sales. A user can maintain contact data, leads data, customer follow-up data, performance data, goals and progress data, etc., all applicable to that user's personal sales process (for example, in tenant database 22). In an example of a MTS arrangement, because all of the data and the applications to access, view, modify, report, transmit, calculate, etc., can be maintained and accessed by a user system 12 having little more than network access, the user can manage his or her sales efforts and cycles from any of many different user systems. For example, when a salesperson is visiting a customer and the customer has Internet access in their lobby, the salesperson can obtain critical updates regarding that customer while waiting for the customer to arrive in the lobby.

While each user's data can be stored separately from other users' data regardless of the employers of each user, some data can be organization-wide data shared or accessible by several users or all of the users for a given organization that is a tenant. Thus, there can be some data structures managed by system 16 that are allocated at the tenant level while other data structures can be managed at the user level. Because an MTS can support multiple tenants including possible competitors, the MTS can have security protocols that keep data, applications, and application use separate. Also, because many tenants may opt for access to an MTS rather than maintain their own system, redundancy, up-time, and backup are additional functions that can be implemented in the MIS. In addition to user-specific data and tenant-specific data, the system 16 also can maintain system level data usable by multiple tenants or other data. Such system level data can include industry reports, news, postings, and the like that are shamble among tenants.

In some implementations, the user systems 12 (which also can be client systems) communicate with the application servers 100 to request and update system-level and tenant-level data from the system 16. Such requests and updates can involve sending one or more queries to tenant database 22 or system database 24. The system 16 (for example, an application server 100 in the system 16) can automatically generate one or more SQL statements (for example, one or more SQL queries) designed to access the desired information. System database 24 can generate query plans to access the requested data from the database. The term “query plan” generally refers to one or more operations used to access information in a database system.

Each database can generally be viewed as a collection of objects, such as a set of logical tables, containing data fitted into predefined or customizable categories. A “table” is one representation of a data object, and may be used herein to simplify the conceptual description of objects and custom objects according to some implementations. It should be understood that “table” and “object” may be used interchangeably herein. Each table generally contains one or more data categories logically arranged as columns or fields in a viewable schema. Each row or element of a table can contain an instance of data for each category defined by the fields. For example, a CRM database can include a table that describes a customer with fields for basic contact information such as name, address, phone number, fax number, etc. Another table can describe a purchase order, including fields for information such as customer, product, sale price, date, etc. In some MTS implementations, standard entity tables can be provided for use by all tenants. For CRM database applications, such standard entities can include tables for case, account, contact, lead, and opportunity data objects, each containing pre-defined fields. As used herein, the term “entity” also may be used interchangeably with “object” and “table.”

In some MTS implementations, tenants are allowed to create and store custom objects, or may be allowed to customize standard entities or objects, for example by creating custom fields for standard objects, including custom index fields. Commonly assigned U.S. Pat. No. 7,779,039, titled CUSTOM ENTITIES AND FIELDS IN A MULTI-TENANT DATABASE SYSTEM, by Weissman et al., issued on Aug. 17, 2010, and hereby incorporated by reference in its entirety and for all purposes, teaches systems and methods for creating custom objects as well as customizing standard objects in a multi-tenant database system. In some implementations, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

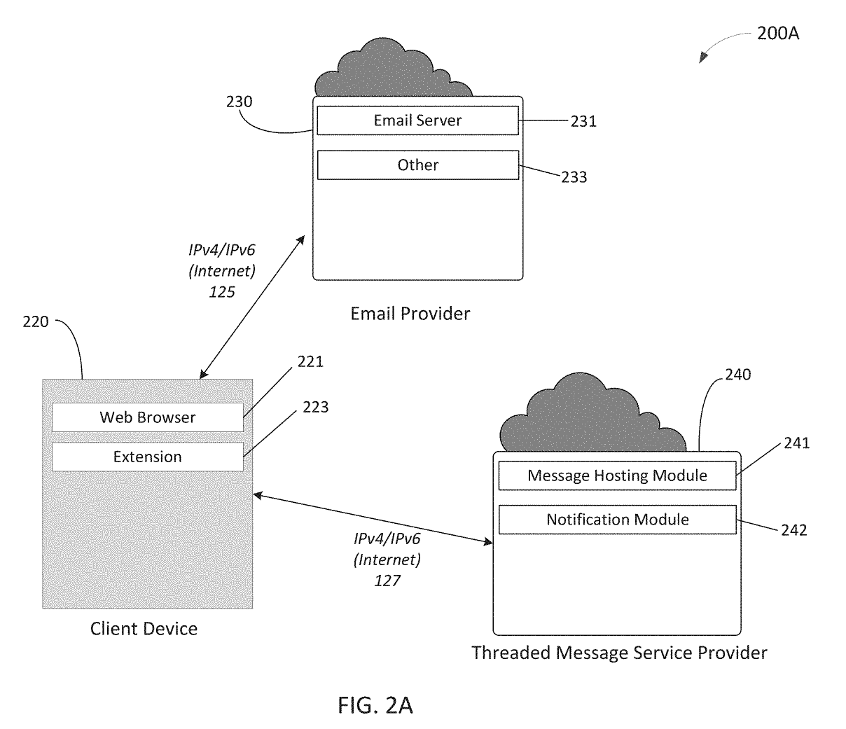

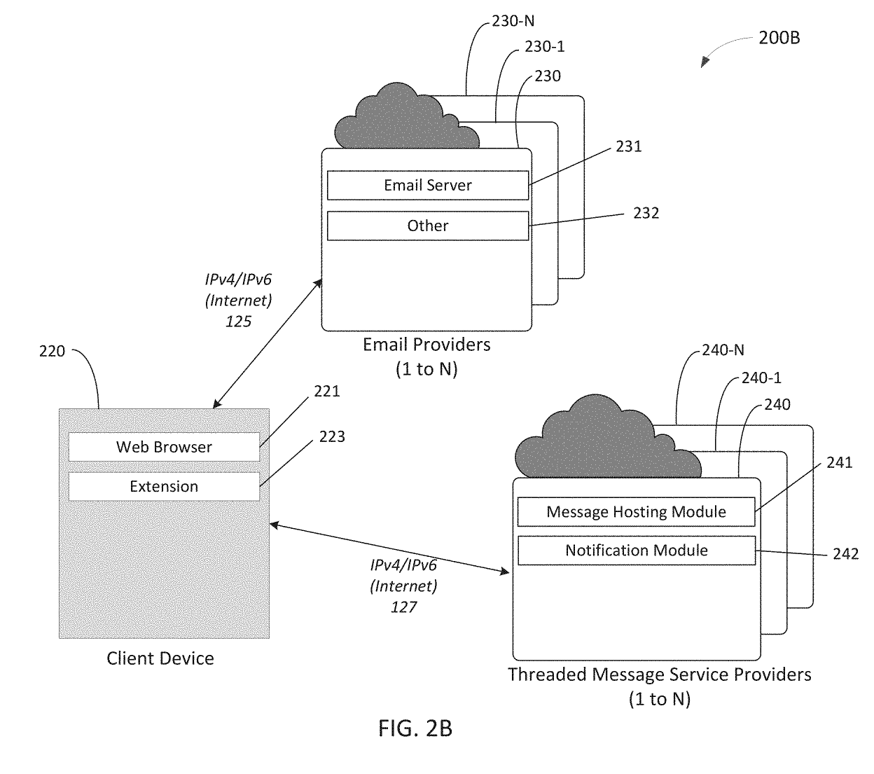

Referring now to FIG. 2A, an example system for live updating of emails according to the present disclosure, in accordance with various embodiments, is illustrated. As shown, system 200A may include a Client Device 220. Client Device 220 may be one or more hardware devices and/or one or more software modules that carry out web browsing for one or more users of the user device. In embodiments, the one or more hardware devices may be tamper resistant and the operations may be carried out independent of processor(s) of a host/application platform. In embodiments Where Client Device 220 is implemented as one or more software modules, the software modules may include “enclaves” which may ne isolated regions of code and/or data within the memory of a computing platform.

Client Device 220 may communicate with a cloud based Threaded. Message Service Provider 240 of system 200A, as described below. As shown, Client Device 220 may communicate with Threaded Message Service Provider 240 over an Internet connection 227, which may operate under Internet Protocol (“IP”) IPv4 or IPv6, in various embodiments. In embodiments, Client Device 220 may include a Web Browser 221, which may access various web addresses and websites as directed by a user of Client Device 220, Web Browser 221 may be used, for example, to access one or more email accounts, such as may be provided or hosted by web based email services such as AOL Mail, Gmail, Outlook.com, Hotmail and Yahoo! Mail, for example.

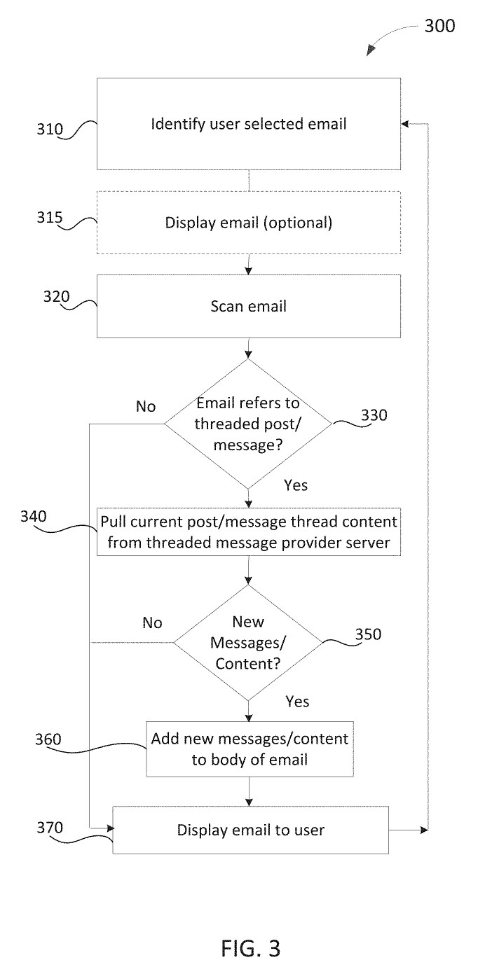

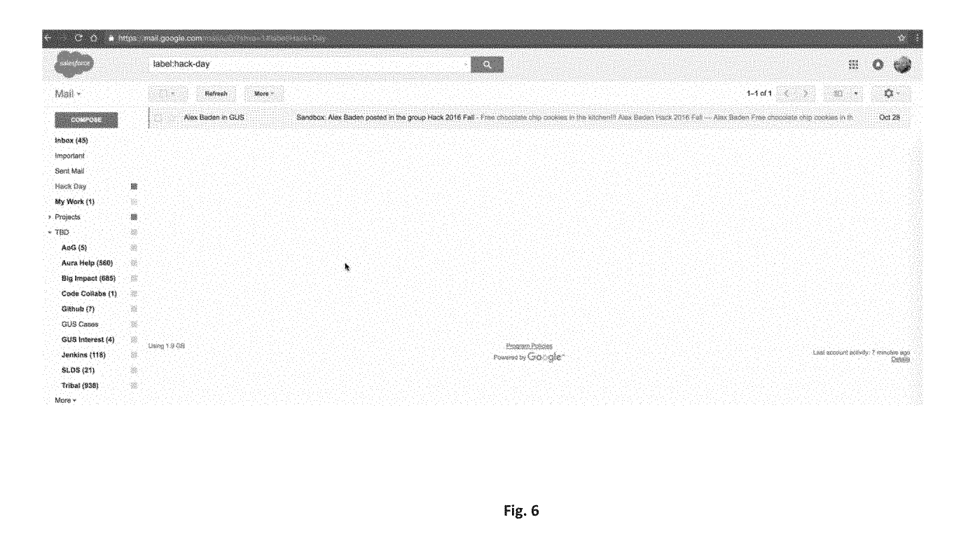

In embodiments, Client Device 220 may also include one or more Extensions 223, which may enhance the capabilities of Web Browser 221, including extending or augmenting how emails may be processed or displayed, as described more fully herein, with reference to FIG. 3. In embodiments, an Extension 223 may be a separate module than Web Browser 221, as shown, or, for example, it may be integrated into a given Web Browser 221 as one integrated product. In embodiments an extension may perform live update of emails in a user account as described below, and in particular with reference to the process of FIG. 3 as illustrated in FIGS. 6-12. Extension 223 may directly communicate with Threaded Message Service Provider 240 through an API and obtain messages from a user's account at Threaded Message Service Provider 240, as described more fully below in connection with the process illustrated in FIG. 3. Client Device 220 may also include an email client, through which a user may access emails other than through Web Browser 221,

Client Device 220 may communicate with a cloud based Email Provider 230 of system 200A, as described below, over a network (also illustrated. schematically by a cloud on Email Provider 230). As shown, Client Device 220 may communicate with Email Provider 230 over an Internet connection 225, which may operate under IPv4 or IPv6, in various embodiments. When Client Device 220 communicates with a cloud based email provider, it may access a user's email account on a web-based email service, such as, for example, Gmail, Yahoo! Mail, AOL Mail, etc.

The network can be or include any network or combination of networks of systems or devices that communicate with one another. For example, the network can be or include any one or any combination of a LAN (local area network), WAN (wide area network), telephone network, wireless network, cellular network, point-to-point network, star network, token ring network, hub network, or other appropriate configuration. The network can include a TCP/IP (Transfer Control Protocol and Internet Protocol) network, such as the global internetwork of networks often referred to as the “Internet” (with a capital “I”). The Internet will be used in many of the examples herein. However, it should be understood that the networks that the disclosed implementations can use are not so limited, although TCP/IP is a frequently implemented protocol.

Client Device 220 may communicate with other elements of system 200A using TCP/IP and, at a higher network level, other common Internet protocols to communicate, such as HTTP, FTP, AFS, WAP, etc. In an example where HTTP is used, as shown in FIG. 2A, Client Device 220 may include an HTTP client commonly referred to as a “web browser” or simply a “browser” for sending and receiving HTTP signals to and from an HTTP server such as Email Server 231 of Email Provider 230, or such as an HTTP server (not shown) associated with Threaded Message Service Provider 240. Such an HTTP server can be implemented as the sole network interface between Client Device 220 and each of Email Provider 230 and Threaded Message Service Provider 240 and the network, but other techniques can be used in addition to or instead of these techniques. In some implementations, a network interface between each such component of system 200 may include load sharing functionality, such as round-robin HTTP request distributors to balance loads and distribute incoming HTTP requests evenly over a number of servers.

Client Device 220 can be implemented as any computing device(s) or other data processing apparatus or systems usable by users. For example, Client Device 220 can be a desktop computer, a work station, a laptop computer, a tablet computer, a handheld computing device, a mobile cellular phone (for example, a “smartphone”), or any other Wi-Fi-enabled device, wireless access protocol (WAP)-enabled device, or other computing device capable of interfacing directly or indirectly to the Internet or other network. The terms “user system” and “computing device” are used interchangeably herein with one another and with the term “computer,” As described above, each Client Device 220 typically executes an HTTP client, for example, a web browsing (or simply “browsing”) program, such as a web browser based on the WebKit platform, Microsoft's Internet Explorer browser, Apple's Safari, Google's Chrome, Opera's browser, or Mozilla's Firefox browser, or the like, allowing a user to access, process and view information, pages and applications available to it from Internet connections 225 or 227, or the like.

Each Client Device 220 also typically includes one or more user input devices, such as a keyboard, a mouse, a trackball, a touch pad, a touch screen, a pen or stylus or the like, for interacting with a graphical user interface (GUI) provided by the browser on a display (for example, a monitor screen, liquid crystal display (LCD), light-emitting diode (LED) display, among other possibilities) in conjunction with pages, forms, applications and other information provided by other elements of system 200 or other systems or servers. As discussed above, implementations are suitable for use with the Internet, although other networks can be used instead of or in addition to the Internet, such as an intranet, an extranet, a virtual private network (VPN), a non-TCP/IP based network, any LAN or WAN or the like.

According to some implementations, Client Device 220 and some or all of its components are operator-configurable using applications, such as a browser, including computer code executed using a central processing unit (CPU) such as an Intel Pentium® processor or the like.

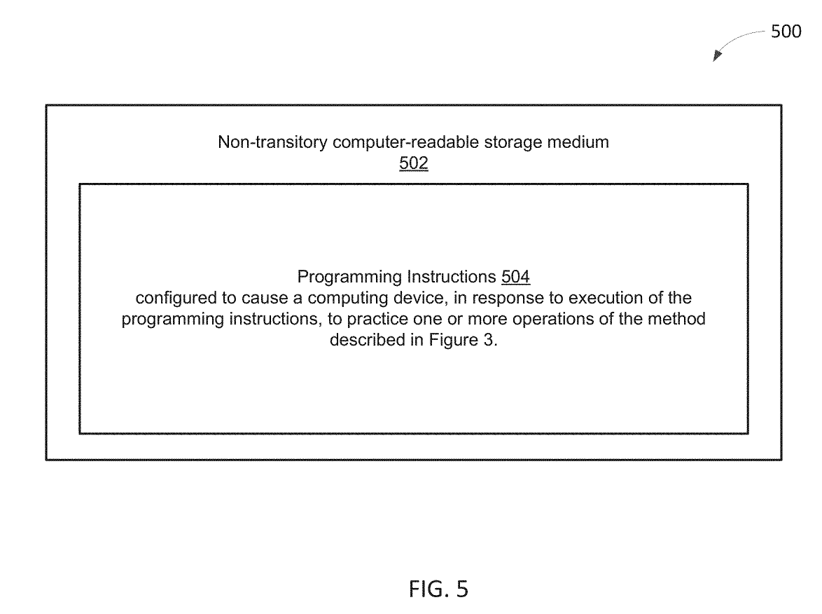

As described more fully below in connection with FIG. 5, Client Device 220 may include tangible computer-readable media having non-transitory instructions stored thereon/in that are executable by or used to program a server or other computing system (or collection of such servers or computing systems) to perform some of the implementation of processes described herein. For example, such computer program code can implement instructions for operating and configuring Client Device 220 to intercommunicate and to process web pages, applications and other data and media content as described herein. In some implementations, the computer code can be downloadable and stored on a hard disk, but the entire program code, or portions thereof, also can be stored in any other volatile or non-volatile memory medium or device as is well known, such as a ROM or RAM, or provided on any media capable of storing program code, such as any type of rotating media including floppy disks, optical discs, digital versatile disks (DVD), compact disks (CD), microdrives, and magneto-optical disks, and magnetic or optical cards, nanosystems (including molecular memory ICs), or any other type of computer-readable medium or device suitable for storing instructions or data. Additionally, the entire program code, or portions thereof, may be transmitted and downloaded from a software source over a transmission medium, for example, over the Internet, or from another server, as is well known, or transmitted over any other existing network connection as is well known (for example, extranet, VPN, LAN, etc.) using any communication medium and protocols (for example, TCP/IP, HTTP, HTTPS, Ethernet, etc.) as are well known. It will also be appreciated that computer code for the disclosed implementations can be realized in any programming language that can be executed on a server or other computing system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

Continuing with reference to FIG. 2A, in embodiments, when a user accesses a web location or URL associated with Email Provider 230, e.g., haps://mail.google.com, via Web Browser 221 on Client Device 220, it may receive emails from one or more email accounts that the user maintains with Email Provider 230. Similarly a user may access email directly, through an email client application provided on Client Device 220.

Additionally, Client Device 220, when a user accesses a web location or URL associated with Threaded Message Service Provider 140, via Web Browser 221, may access numerous posts or threaded messages that are hosted or maintained by Threaded Message Service Provider 240. Such posts or messages may be those that are available to the user via a user account maintained with Threaded Message Service Provider 240, such as a Yahoo™, Facebook™, or Salesforce.com, a customer relationship management (CRM) platform that hosts threaded messages for its users, in an application known as “Chatter”, as described more fully below in connection with FIGS. 6-12. It is noted that the term “threaded message service provider” is herein used interchangeably with “social medium” and is intended and understood to include both “plain” message boards and the like, such as Yahoo Groups, or Google Groups, as well as to more complex social media, such as Facebook™, where users may post messages and attachments to “pages” as well as to “groups.” It is understood that in general, in these various on-line environments, whenever a user may post a message they may also post attachments such as photographs, audio files and video files, which are accessible by activating a link or button in the message thread.

Continuing with reference to FIG. 2A, Email Provider 230 may include Email Server 231 and various other components or modules, shown representatively in FIG. 2A as Other 233. These may include various web-accessible applications that a given email provider may also offer, such as, for example in the case of Google, which offers email services under the Gmail™ service, it also offers various other web-based services, including Google Voice, Google Hangouts, Google Books, etc., which may operate on a Google Gmail server as well. A similar state of affairs may generally prevail for other common web-based email providers, who tend to operate as web portals and offer various suites of web-accessible services, one of which is email. Email Provider 230 may communicate with Client Device 220 over an Internet connection 225, as described above. In embodiments, email Provider 230 may be one or more hardware devices and/or one or more software modules that carry out the provision and management of email as well as such “other” services. In embodiments, the one or more hardware devices may be tamper resistant and the operations may be carried out independent of processor(s) of a host/application platform. In embodiments where Email Provider 230 is implemented as one or more software modules, the software modules may include “enclaves” which may be isolated regions of code and/or data within the memory of a computing platform.

Continuing with reference to FIG. 2A, Threaded Message Service Provider 240 may include Message Hosting Module 241 and various other components or modules. Threaded Message Service Provider 240 may also include Notification Module 242, which may send notification emails to users when a new post or message in a thread that the user has subscribed to, or participated in, occurs. Such posts r messages may also include one or more attachments, including photos, video files, audio files, or the like. Threaded Message Service Provider 240 may communicate with Client Device 220 over an Internet connection 227, as described above. Threaded Message Service Provider 240 may be one or more hardware devices and/or one or more software modules that carry out the provision and management of email as well as such “other” services. In embodiments, the one or more hardware devices may be tamper resistant and the operations may be carried out independent of processor(s) of a host/application platform. In embodiments where Threaded Message Service Provider 240 is implemented as one or more software modules, the software modules may include “enclaves” which may be isolated regions of code and/or data within the memory of a computing platform.

Referring now to FIG. 2B, an alternate system for live updating of emails according to the present disclosure, in accordance with various embodiments, is illustrated. System 200B, shown in FIG. 2B, is an expanded version of system 200 shown in FIG. 2A, such that there may be multiple Email Providers 230, 230-1, . . . 230-N, as well as multiple Threaded Message Service Providers 240, 240-1, . . . 240-N. In all other aspects, system 200B shown in FIG. 2B is equivalent to system 200A shown in FIG. 2A, and elements in each of FIGS. 2A and 2B having the same index numbers are identical. Thus, in system 200B of FIG. 29, a user of Client Device 220 may access multiple web-based email accounts, such as, for example, AOL Mail, Gmail, Outlook.com, Hotmail and Yahoo! Mail, at the same time. Moreover, in each, or any, of those multiple web-based email accounts, a user may receive email notifications from multiple threaded message service providers, such as Threaded Message Service Providers 240, 240-1, . . . 240-N. In the more complex system of FIG. 2B, Extension 223 on Client Device 220 can directly communicate with each of Threaded Message Service Providers 240, 240-1, . . . 240-N over an API, and obtain messages from a user's account at each of them.

Referring now to FIG. 3, operational flow for a processes of live updating of an email is illustrated.

As illustrated, process 300 may include operations performed at blocks 310-370. The operations may be performed by Extension 223 of Client Device 220 in FIG. 2A, or by the equivalent Extension 223 of Client Device 220 in FIG. 2B. In embodiments, process 300 addresses dealing with emails in a user's web-based email account, identifying those emails that originate from a threaded message service provider, and updating the emails live, or in real time, whenever they are opened.

Process 300 may begin at block 310. At block 310, identification of an email selected by a user for opening in a browser may be received. From block 310 process 300 may optionally proceed to block 315, where the selected email may be displayed to the user as is. This is an optional feature, inasmuch as if the email is one that will be updated at block 360 and then displayed at block 370 anyway, there is no real need to display its contents without, or prior to, such updating. However, in embodiments, when updating an email with contents accessed from a threaded message service provider, where network conditions may introduce a perceptible delay, it may be desirable to first display the original email, and While it is open let it be updated while the user views it. In other embodiments, it may be simpler just to first display the email to the user as fully updated.

From block 310, or block 315 if that optional path is implemented, process 300 may proceed to block 320, where the user selected email may be scanned. It is from this scan that Extension 223 of FIGS. 2A or 2B obtains the details of the email that indicate both who it is from, and what it is about. The extension uses that information to determine if the email is from a threaded message service provider, and if so, which thread in that service provider's message boards, e.g., a Salesforce Chatter® post, or which post in its social media environment, e. a Facebook™ post, the email refers and links to. It is here noted that while this information is not usually visible to a user opening an email in an email program, every email has additional data that may be accessed by a browser that indicate, inter alia, the origin of the email. In addition, threaded message service providers generally each have a different identification system for identifying their posts and messages, and thus each notification email that originates at a given threaded message service provider will contain unique data that may be used to identify them, and also which specific post, page, or message thread their notification email refers to. This unique data may be known as a “descriptor”, and taking all such descriptors together, one may speak of a “signature” of, for example, a specific Facebook post on the “Anthony Bourdain” page (https://www.facebook.com/AnthonyBourdain/) that an email extension, in accordance with various embodiments, can use to identify whether or not an email is from a threaded message service provider, and if so, which of its message threads, posts, or the like, it refers to.

Thus, from block 320 process 300 may proceed to block 330, where it is determined (from the scanned email) whether the email refers to a post or message on another platform, at a different URL. Because it cannot be known whether or not a given email is a notification of, or refers to, a posting on another platform or is just a stand-alone message, process 300 scans each email that a user decides to open. If “No” at block 330, then process flow jumps to block 370 where the email is simply displayed to a user, without embellishment, as in the normal course of using an email client. However, if at block 330 the answer is “Yes”, then from block 330, process 300 may proceed to block 340, where the post or message referred to in the email is accessed, via an API, and the then current content pulled from the threaded message service provider's website or platform, as the case may be.

It is noted that, in embodiments, the API can extract the relevant post or message thread, and then simply accesses the message service provider's website as if it were the user, using the user's credentials. As noted above, a message notification email generally contains all of the information that the API needs to do this, so the API does not need to ever search the message service provider's website. Thus, the “descriptor” or “signature” obtained from scanning the email is, or includes, a unique ID of, for example, Facebook, and a specific post on Facebook. Thus, in embodiments, there is no need for the API to “search” through, for example, Facebook, Chatter®, or the like, to find the relevant message thread.

Continuing with reference to FIG. 3, from block 340, process 300 may proceed to query 350, where it may be determined if the contents of the message thread or post on the threaded message service provider's website or platform includes new content. This may be determined by comparing the contents of the original email as selected by the user with the actual post on the threaded message service provider's website or platform. Alternatively, it may be determined by comparing the time the original email was sent with the timing of the various messages posted on the thread on the threaded message service provider's website or platform. If “No” at query 350, then process flow jumps to block 370 where the email is simply displayed to a user, without embellishment, as above.

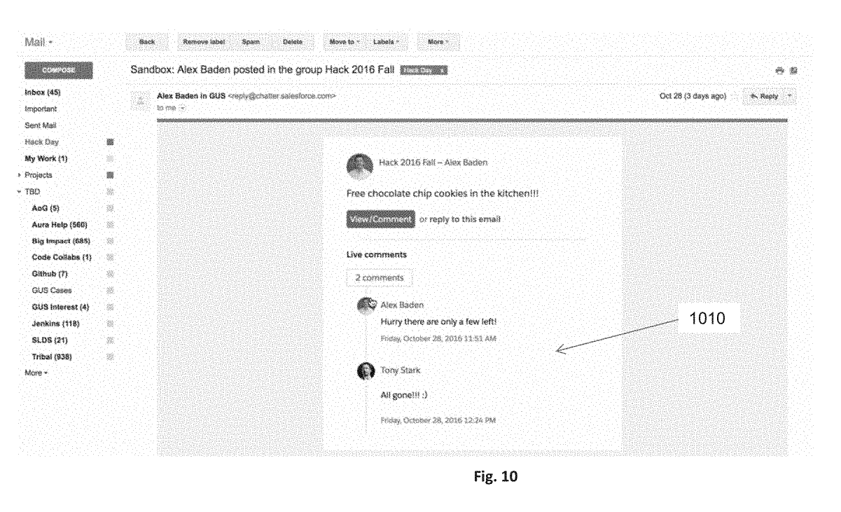

However, if “Yes” at query 350, then process 300 may proceed to block 360, where the new content from the message post is added to the body of the email, and process 30 may proceed to block 370, where the email is displayed to the user as augmented by the additional new content pulled by process 300 at block 340. The displayed augmented message now has all of the then current information, for example, as shown at 1010 in FIG. 10, and the user need not click on the link to threaded message service provider's website or platform to get updates. Extension 223 has done the updating automatically. At block 370 process 300 may begin again at block 300, with the next email selected by the user to open. Thus, process 300 may run in a continuous loop within Extension 223 as long as the user is accessing emails via, for example, Web Browser 221.

It is noted that while process 300 of FIG. 3 was described for a user accessing emails through a web browser, and thus the enhanced functionality of live update of emails provided by an extension to such a web browser, in alternate embodiments an essentially identical process can occur with a plug-in, or enhancement, to an email client running on a client device. In such alternate embodiments the emails are accessed via such an email client, not via a web browser, but the enhanced functionality is supplied by a plug-in or enhancement to the email client. In all other aspects, the analogous process operates identically to process 300. Thus, the email client scans each email that a user decides to open, and determines (from the scanned email) whether the email refers to a post or message on another platform, at some URL. If no, then process flow proceeds to where the email is simply displayed to a user, without embellishment, as in the normal course of using the email client. However, if yes, then process flow proceeds to where the post or message referred to in the email is accessed, via an API, and the then current content pulled from the threaded message service provider's website or platform, as the case may be.

Such an email client based process may then determine if the contents of the message thread or post on the threaded message service provider's website or platform includes new content. As described above for process 300, this may be determined by comparing the contents of the original email as selected by the user with the actual post on the threaded message service provider's website or platform. Alternatively, it may be determined by comparing the time the original email was sent with the timing of the various messages posted on the thread on the threaded message service provider's website or platform. If no then the email is simply displayed to a user, without embellishment, as above. If yes, then the new content from the message post may be added to the body of the email, and the email displayed to the user as augmented by the additional new content pulled by the API. The displayed augmented message now has all of the then current information, for example, as shown at 1010 in FIG. 10, and the user need not click on the link to threaded message service provider's website or platform to get updates. The email client plug-in has done the updating automatically. The process may begin again, with the next email selected by the user to open. Thus, such an alternate process may run in a continuous loop as long as the user is accessing emails via the email client on the user device.

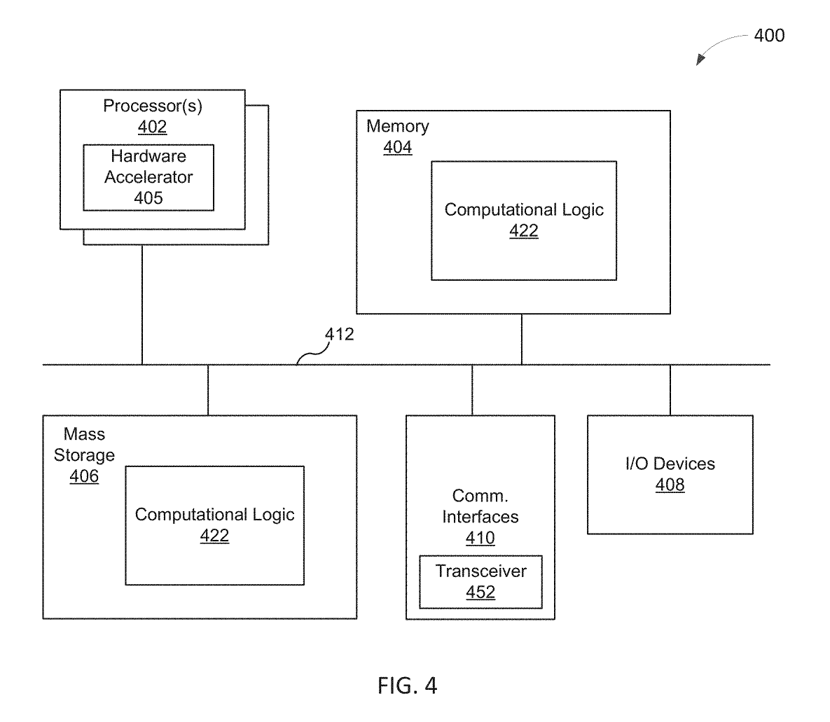

Referring now to FIG. 4, wherein a block diagram of a computer device suitable for practicing the present disclosure, in accordance with various embodiments, is illustrated. As shown, computer device 400 may include one or more processors 402, memory controller 403, and system memory 404. Each processor 402 may include one or more processor cores and/or hardware accelerator 405. An example of hardware accelerator 405 may include, but is not limited to, programmed field programmable gate arrays (FPGA). Memory controller 403 may be any one of a number of memory controllers known in the art. System memory 404 may include any known volatile or non-volatile memory.

Additionally, computer device 400 may include mass storage device(s) 406 (such as solid state drives), input/output device interface 408 (to interface with various input/output devices, such as, mouse, cursor control, display device (including touch sensitive screen), and so forth) and communication interfaces 510 (such as network interface cards, modems and so forth). In embodiments, communication interfaces 510 may support wired or wireless communication, including near field communication. The elements may be coupled to each other via system bus 512, which may represent one or more buses. In the case of multiple buses, they may be bridged by one or more bus bridges (not shown).

Each of these elements may perform its conventional functions known in the art. In particular, system memory 404 and mass storage device(s) 406 may be employed to store a working copy and a permanent copy of the executable code of the programming instructions of an operating system, one or more applications, Web Browser 221, Extension 223, Email Server 231, Other 233, Message Hosting Module 241 and Notification Module 242, as well as each of their respective counterparts shown in the alternate system 200B of FIG. 2B, collectively referred to as computing logic 422. Extension 223, or alternatively Web Browser 221, or still alternatively Web Browser 221, in combination with Extension 223, may be configured to practice (aspects of) process 300 of FIG. 3, described above. The programming instructions may comprise assembler instructions supported by processor(s) 402 or high-level languages, such as, for example, C, that can be compiled into such instructions. In embodiments, some of computing logic may be implemented in hardware accelerator 405.

The permanent copy of the executable code of the programming instructions or the bit streams for configuring hardware accelerator 405 may be placed into permanent mass storage device(s) 406 in the factory, or in the field, through, for example, a distribution medium (not shown), such as a compact disc (CD), or through communication interface 410 (from a distribution server (not shown)).

The number, capability and/or capacity of these elements 410-412 may vary, depending on the intended use of example computer device 400, e.g., whether example computer device 400 is a smartphone, tablet, ultrabook, a laptop, a server, a set-top box, a game console, a camera, and so forth. The constitutions of these elements 410-412 are otherwise known, and accordingly will not be further described.

FIG. 5 illustrates an example computer-readable storage medium having instructions configured to implement all (or portion of) Web Browser 221, Extension 223, Email Server 231, Other 233, Message Hosting Module 241, Notification Module 242, and/or practice (aspects of) process 300 of FIG. 3, earlier described, in accordance with various embodiments. As illustrated, computer-readable storage medium 502 may include the executable code of a number of programming instructions or bit streams 504. Executable code of programming instructions (or bit streams) 504 may be configured to enable a device, e.g., computer device 400, in response to execution of the executable code/programming instructions (or operation of an encoded hardware accelerator 405), to perform (aspects of) process 300 of FIG. 3, respectively. In alternate embodiments, executable code/programming instructions/bit streams 504 may be disposed on multiple non-transitory computer-readable storage medium 502 instead. In embodiments, computer-readable storage medium 502 may be non-transitory. In still other embodiments, executable code/programming instructions 504 may be encoded in transitory computer readable medium, such as signals.

Referring back to FIG. 4, for one embodiment, at least one of processors 402 may be packaged together with a computer-readable storage medium having some or all of computing logic 422 (in lieu of storing in system memory 404 and/or mass storage device 406) configured to practice all or selected ones of the operations earlier described with reference to FIG. 3. For one embodiment, at least one of processors 402 may be packaged together with a computer-readable storage medium having some or all of computing logic 422 to form a System in Package (SiP). For one embodiment, at least one of processors 402 may be integrated on the same die with a computer-readable storage medium having some or all of computing logic 422. For one embodiment, at least one of processors 402 may be packaged together with a computer-readable storage medium having some or all of computing logic 422 to form a System on Chip (SoC). For at least one embodiment, the SoC may be utilized in, e.g., but not limited to, a hybrid computing tablet/laptop.

Referring to FIGS. 6-12, various screen shots of an example actual live email update is illustrated, in accordance with various embodiments. These figures are next described.

FIG. 6 is a screen shot of an email received in a web-based email account, notifying the user of a post in a group on a Salesforce.com platform in accordance with various embodiments. In this example, the email provider is Google's Gmail, and only one email is shown in the queue because the user has searched for emails having a label “hack-day” as shown in the search bar in the upper left of the screen. It is also noted that the email was sent on October 28, which was three days earlier than the day the user opened this email, as shown in the upper right hand corner of the screen.

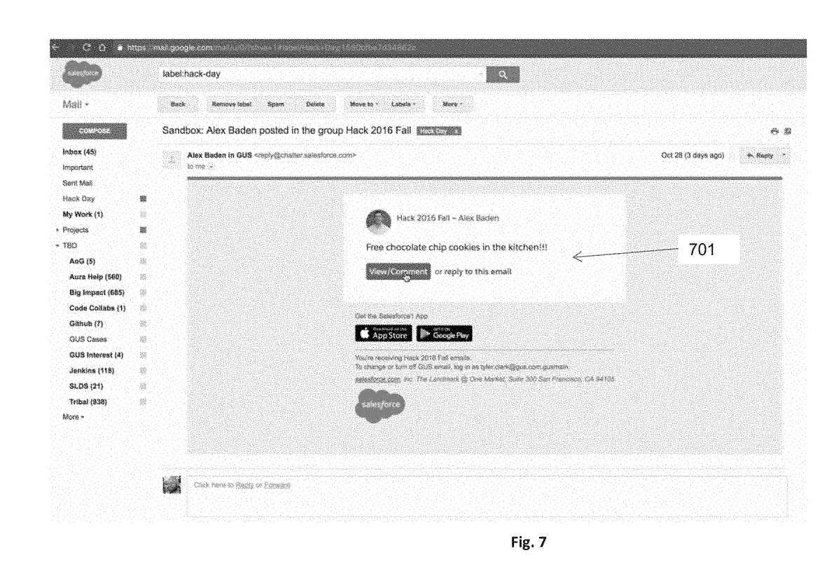

FIG. 7 illustrates the email shown in FIG. 6, after the user has opened it. As shown at 701, the email reports a message posted on Chatter®, and has a time sensitive message, advising that there are (at the time of the email) free cookies in the kitchen. The email also contains a link to the Chatter® website, indicated by the active button View/Comment at 701, which, if the user clicks on it, a new browser window will open showing the Chatter® website at salesforce.com.

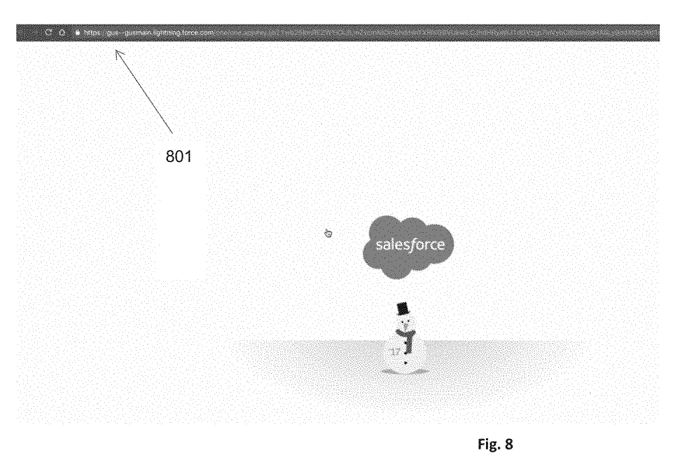

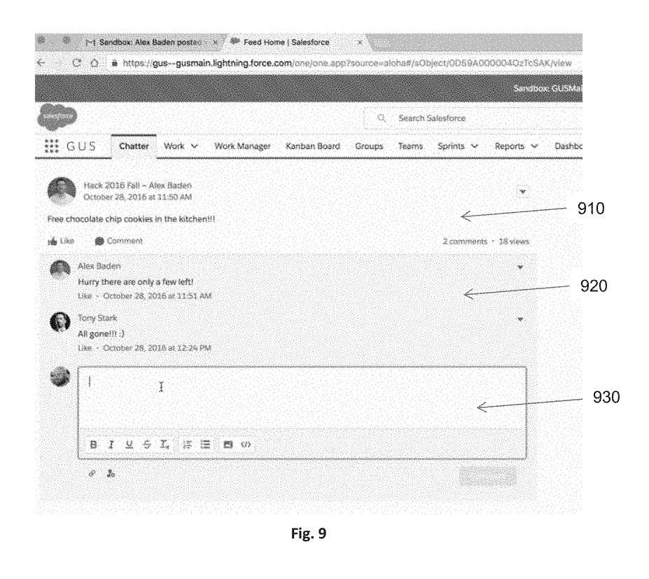

FIG. 8 illustrates the result of the user doing just that, and the salesforce website is in the process of opening, the URL for the salesforce website is shown at 801 in FIG. 8. Once opened, it is shown in a second browser window in FIG. 9 (the browser window for the Gmail website indicated by the tab at the top right of FIG. 9). Thus, FIG. 9 is a screen shot of the opened message thread on Chatter®. As may readily be seen, the original message 910 shown in the notification email of FIG. 7 is not the last message in this thread. Rather, two new comments have been posted at 920, the last of which, made at about 30 minutes after the original message 910, indicates that actually the cookies are all gone. Finally, there is a new comment box at 930, which a Chatter® user may post in.

Referring to FIG. 10, a screen shot is shown of the original notification email, as shown in FIG. 7, but here the email has been augmented with the new posts shown at 920 in FIG. 9, in accordance with various embodiments. As noted above with reference to FIG. 3, the situation shown in FIG. 10 may be the first time the email is displayed, as per block 370 of FIG. 3, or it may first have been displayed without the augmented comments, as per optional block 315 of FIG. 3, and then updated while the user has the email open, and then displayed with all of the updated comments, as per block 370 of FIG. 3. FIG. 10 is a screen shot, once again, of the user's Gmail account, in the first browser window the user opened in this example. Thus, the email shown in FIG. 6 in the user's queue, and selected for opening and opened as shown in FIG. 7, has now been automatically updated with the subsequently posted messages from the message thread on the Salesforce.com platform. Thus, the user is relieved of the task of clicking on links in message notification mails, because, in various embodiments, the notification emails automatically update themselves each time a user opens one.

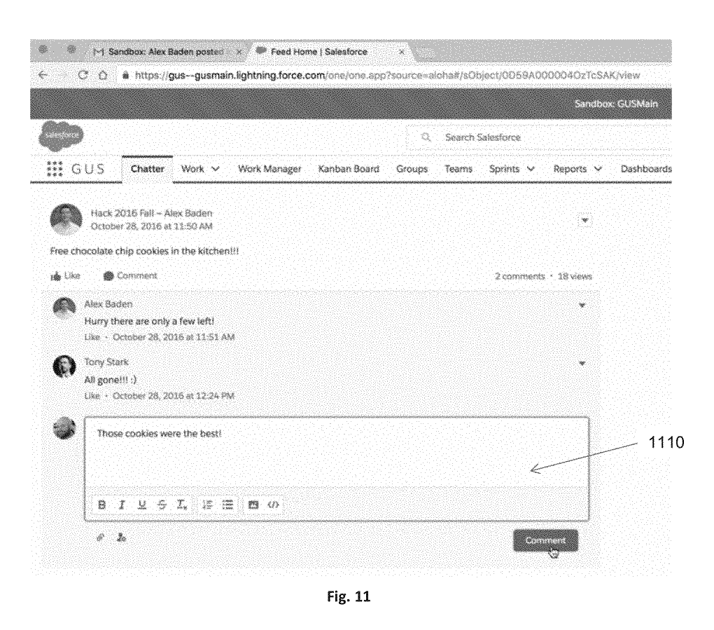

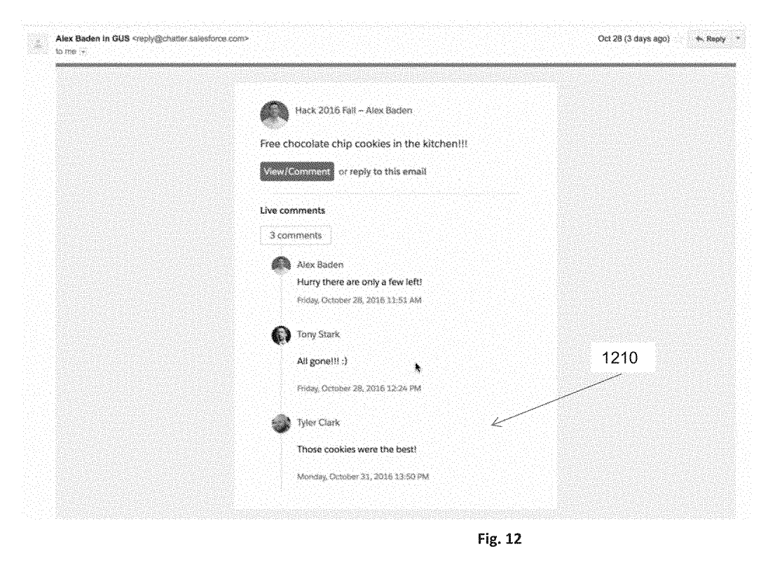

FIGS. 11 and 12 illustrate a real-time live update aspect according to various embodiments. In the updates illustrated in FIGS. 9 and 10, the additional message posts shown at 920 in FIG. 9 were also made on Oct. 28, 2016, the same day as the original message which is the subject of the email shown in FIG. 7 This was three days prior to the date the user first opened up the message notification email shown in FIG. 7. But, as noted above with reference to FIG. 9, a user of Chatter® may always post a new message, in a field as shown at 930 in FIG. 9. The live update feature for such newly posted messages is illustrated in FIGS. 11 and 12.

FIG. 11 is similar to the screen shot shown in FIG. 9, except that in FIG. 11 a Chatter® user (here it happens to be the same user of the email account shown in FIG. 6) has posted a new message: “Those cookies were the best!”. As can readily be seen in FIG. 11, this exemplary user has two browser windows open, his Gmail account in the rightmost window, and his Chatter® account in the leftmost window. FIG. 12 illustrates the same email as that shown in FIG. 10, right after the user finished his comment on Chatter®, as shown in FIG. 11. As can readily be seen, the original email of FIG. 7 has now been updated in real time (on Oct. 31, 2016) with the new message just entered on the Salesforce.com platform Chatter® message thread, in what is a live update.

As noted above in connection with FIG. 2B, a user may have multiple web-based email accounts, as well as accounts at multiple threaded message service providers. In embodiments, each notification email, on any of the users email accounts, from any of his or her threaded message service providers may be live updated as described above. It is also noted that, in general, a user will receive a new notification email each time a new post is made to a message thread or post that the user has requested (or by default simply receives) from a threaded message service provider. Because the process of FIG. 3 updates each such email with the total then current content of the post or message thread, opening any notification email, whenever received, will provide the user with a full update of the post or message thread. Thus, users who formerly sifted through multiple days' worth of emails, need only choose one, and may delete the others.

The specific details of the specific aspects of implementations disclosed herein may be combined in any suitable manner without departing from the spirit and scope of the disclosed implementations. However, other implementations may be directed to specific implementations relating to each individual aspect, or specific combinations of these individual aspects. Additionally, while the disclosed examples may include those with reference to an implementation in which an on-demand database service environment is implemented in a system having an application server providing a front end for an on-demand database service capable of supporting multiple tenants, the present implementations are not limited to multi-tenant databases or deployment on application servers. Implementations may be practiced using other database architectures, i.e., ORACLE®, DB2® by IBM and the like without departing from the scope of the implementations claimed. As shown in FIGS. 2A and 2B, in general, implementations may be practiced without use of multi-tenant databases, and without deployment on application servers.

It should also be understood that some of the disclosed implementations can be embodied in the form of various types of hardware, software, firmware, or combinations thereof, including in the form of control logic, and using such hardware or software in a modular or integrated manner. Other ways or methods are possible using hardware and a combination of hardware and software. Additionally, any of the software components or functions described in this application can be implemented as software code to be executed by one or more processors using any suitable computer language such as, for example, Java, C++ or Pert using, for example, existing or object-oriented techniques. The software code can be stored as a computer- or processor-executable instructions or commands on a physical non-transitory computer-readable medium. Examples of suitable media include random access memory (RAM), read only memory (ROM), magnetic media such as a hard-drive or a floppy disk, or an optical medium such as a compact disk (CD) or DVD (digital versatile disk), flash memory, and the like, or any combination of such storage or transmission devices.

Computer-readable media encoded with the software/program code may be packaged with a compatible device or provided separately from other devices (for example, via Internet download). Any such computer-readable medium may reside on or within a single computing device or an entire computer system, and may be among other computer-readable media within a system or network. A computer system, or other computing device, may include a monitor, printer, or other suitable display for providing any of the results mentioned herein to a user.

While some implementations have been described herein, it should be understood that they have been presented by way of example only, and not limitation, Thus, the breadth and scope of the present application should not be limited by any of the implementations described herein, but should be defined only in accordance with the following and later-submitted claims and their equivalents.

What is claimed is:

1. A method of updating an email, comprising:
identifying an email selected for opening by a user on a client device;
scanning the email;
determining if the email refers to a message thread or social media post on a message service provider's server;
obtaining contents of the message thread or social media post that were added subsequent to the sending of the email from the message service provider's server; and
displaying the email to the user with the added contents.

2. The method of claim 1, wherein the email is provided by a web-based email provider, accessed via a web browser provided on the client device.

3. The method of claim 2, wherein the web browser is augmented by an extension, also provided on the client device, the extension to perform the scanning, determining and obtaining.

4. The method of claim 1, wherein the identifying includes receiving a signal sent by a user to an email system, via a user interface, to open the email.

5. The method of claim 1, wherein the determining includes processing the scanned email to find data or identifiers uniquely identifying a message service provider and a specific post or thread on a platform of the message service provider.

6. The method of claim 5, wherein the data or identifiers include a message or post identifier.

7. The method of claim 5, wherein the data or identifiers include a format for organizing a message or post notification within an email.

8. The method of claim 5, wherein the data or identifiers include a format for providing a link to the message or social media post within an email.

9. The method of claim 5, wherein the email client is augmented by an extension, the extension performing the scanning, determining and obtaining.

10. The method of claim 1, wherein the email is provided to the user by an email client running on the client device, the email client augmented by an extension, also provided on the client device, the extension performing the scanning, determining and obtaining.

11. The method of claim 1, wherein the determining includes determining which of a plurality of message service providers has sent the email.

12. The method of claim 3, wherein the obtaining includes accessing, by the extension, the message service provider's server via an API.

13. The method of claim 1, wherein obtaining contents of the message or post that were added subsequent to the sending of the email includes obtaining files attached to a post.

14. The method of claim 1, further comprising first displaying the email to the user upon identification, and subsequently displaying the email with the added contents.

15. A computer program stored on a storage medium for updating an email selected by a user, the computer program comprising a set of instructions operable to cause a computer to:
identify an email selected for opening by a user on a client device;
scan the email;
determine if the email refers to a message thread or social media post on a message service provider's server;
obtain contents of the message thread or social media post that were added subsequent to the sending of the email from the message service provider's server; and
display the user with the added contents.

16. The computer program of claim 15 further comprising instructions operable to cause the computer to process the scanned email to find data or identifiers uniquely identifying a message service provider and a specific post or thread on a platform of the message service provider.

17. The computer program of claim 15, wherein the data or identifiers include a message or post identifier.

18. The computer program of claim 15, wherein the data or identifiers include a at least one of a format for organizing a message or post notification within an email, or a format for providing a link to the message or social media post within an email.

19. The computer program of claim 14 further comprising instructions operable to cause the computer to obtain contents of the message thread or social media post via an API, using the user's credentials on the message service provider's server.

20. The computer program of claim 15, wherein obtaining contents of the message or post that were added subsequent to the sending of the email includes obtaining files attached to a post.

21. The computer program of claim 15 further comprising instructions operable to cause the computer to first display the email to the user upon identification, and subsequently displaying the email with the added contents.

22. A method, comprising:
identifying an email in an email system to be displayed to a user, the email including a content;
identifying an identifier associated with the email;
transmitting the identifier to a server;
receiving, based on the identifier, additional data from the server;
modifying the content of the email based on the additional data; and
displaying the email to the user.

23. The method of claim 22, further comprising additionally displaying the email to the user upon identification, and displaying the modified email after modifying the content.
